(19) United States
(12) Patent Application Publication
(10) Pub. No.: US 2004/0148856 A1
(43) Pub. Date: Aug. 5, 2004

(54) Two containers facilitate the watering and nourishing of plants grown in containers

(76) Inventor: George Marshall Sawyer, Orem, UT (US)

Correspondence Address: George Marshall Sawyer, 1360 W 130 S, Orem, UT, 84058, US

(21) Appl. No.: 10/358,537

(22) Filed: Feb. 5, 2003

(51) Int. Cl. A01G 25/00

(52) U.S. Cl. 47/81

(57) ABSTRACT

The invention comprises two containers that are used to facilitate the watering and nourishing of plants grown in containers.

Processes are taught that employ two containers that facilitate the watering of plants grown in containers and includes plants grown in soil and in hydroponic apparatus. A process is taught that moves water from an exterior container into the root growing space of a growing plant. Also, a process is taught for aerating the water that is used for watering the plants. Also, a process is taught for visually determining the level of the nutrient solution in a hydroponic apparatus even thought the apparatus is covered with an opaque covering. Also, convenient processes are taught for replenishing a depleted nutrient solution in a hydroponic apparatus with new solution.

### FIELD OF THE INVENTION

The present invention generally relates to the growing of plants in containers. The invention relates to plants growing in a hydroponic apparatus and plants growing in soil. The invention focuses on means for watering and means for providing nutrient requirements.

### BACKGROUND OF THE INVENTION

Is there a need for improvement? The Encyclopaedia Britannica, Ed of 1960, states, “Hydroponics . . . refers to the growing of plants without soil and is sometimes called soil-less gardening . . . . For many years in the study of their nutrition, plants were grown with their roots immersed in solutions, but the commercial adoption of this method of culture was not entirely successful because of difficulties in plant support and solution aeration.”

The instant invention comprises improved aeration of roots of plants grown in containers.

Prior art has used a siphon for the purpose of conducting water from an external water container into the root growing space of a planter. A conventional water siphon is typically a tube that conducts water up out of a container, in which the water is located, up over the top of the container, and down to a level where the discharge end of the tube is lower than the surface of the water in the container.

### OBJECTIVE OF THE INVENTION

The objective of the invention is to teach processes of making it easier for watering plants and feeding them. One often hears the use of the term “green thumb” to denote someone who already knows how to successfully provide water and the required plant food. An objective of the invention is to make it easier for a person who does not have a green thumb to have great success, provided that that person already has the ability to follow directions or a recipe in making something, as a cherry pie.

The inventor has employed the teachings of the invention described herein to grow, among other things, marigolds, portulacas, and purple morning glories within his laboratory. If one were to see the plants just mentioned, that person would witness the bright clean colors, the robustness of the plants, and would exclaim, “How beautiful!!” The teachings of the invention are just not “pies in the sky” of fanciful and impractical thoughts of the inventor; these teachings have been put into practice by the inventor, and they work. The result is that the teachings take some of the guesswork out how much to water and how much plant food to use. These objectives are accomplished by the use of two containers, as more fully described later in this document.

### SUMMARY OF THE INVENTION

A wick can be used to move water from a first container to a second container, and is self starting.

The second container can be a container in which plants are growing.

The second container can be a container in which plants are growing and the plants are growing in soil.

The second container can be a container in which plants are growing and the plants are growing in a hydroponic apparatus.

The discharge end of the wick can have a stick attached thereto as an aid in placing that end of the wick down into soil or down into the nutrient solution of a hydroponic apparatus.

The wick may be covered with a covering so that it is not exposed to air and still move water from the first container to the second container.

The wick may have no covering and thus be exposed to air and still move water from the first container to the second container. In this case, air permeates the water in the wick and the water in the wick is thus oxygenated and this oxygenated air provides the roots of a growing plant with oxygen, as oxygen is a necessity for growing roots.

It is to be understood that both the foregoing general description and the following detailed description are exemplary and exemplary only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a vertical cross sectional view of a container, water, and a siphon;

FIG. 2 is a vertical cross sectional view of two containers, water, and a siphon;

FIG. 3 is a vertical cross sectional view of a container, water, and a wick;

FIG. 4 is a vertical cross sectional view of two containers, water, and a wick;

FIG. 5 is a vertical cross sectional view of two containers, water, and a wick;

FIG. 6 is a vertical cross sectional view of two containers, water, and a wick;

FIG. 7 is a vertical cross sectional view of two containers, and water.

### DETAILED DESCRIPTION OF THE INVENTION

Reference will now be made in detail to the presently preferred embodiments of the invention, examples of which are illustrated in the accompanying drawings.

In prior art, FIG. 1 depicts a conventional siphon showing a water container 101, water 102, a tube 103, and water 104 therein; the tube and water therein forms a siphon. Because the discharge end 105 of the siphon is below the water level 106 of the water 102, water will flow through the siphon until the water level 106 drops below the inlet end 108 of the siphon at which time the siphon will suck in air and stop working. Container 101 rests on table 107.

In prior art, FIG. 2 depicts water being siphoned out of one container 201 into a second container 202; water will flow until the water level in each of the containers is equal or until the inlet 205 end of siphon 203 is exposed to air at which time the water will drain out of the tube and the siphon will stop working. Container 202 represents a container in which plants are growing; the plants may be growing in soil or hydroponically, and the container may rest on table top 206. There is a decided disadvantage of using a siphon for watering the plants in a container. First, one must get the siphon started, and this means sucking on one end of the tube until water completely fills the tube with the result that some of the water gets in ones mouth, and then it is required to put fingers over the ends of the tube to prevent the water from leaking out as one places one end of the tube in one of the containers and the other in the other container. If the reader has ever tried this, they will probably have found it a tricky procedure. It will be noted that the process is not self starting in that if one places one end of an empty tube in one container and the other end of tube in the other container, nothing happens by itself, even if both ends are submerged; it is required to suck water into the tube to get it started. It is also to be noted that, if the sidewall 204 of the tube is cut so that air can leak in or if air is allowed to enter either end, the siphon will stop working as air enters and the water inside the tube drains down into the containers.

This inventor has discovered that an absorbent material (described as a wick) can be used instead of a siphon. This is a feature of great importance in that the wick is self starting, whereas the siphon is not self starting. Additionally, if the side of a siphon is cut, it will stop working; if the side of a wick is cut, it will continue working.

A convenient material to try out the embodiments of the invention is a piece of Viva brand paper towels because it does not disintegrate when wet. Viva towels comprise natural wood fibers and are available in many grocery stores; it is produced by Kimberly Clark Corporation in Neenah, Wis. The best material is that the inventor has found is a synthetic fiber of acrylic, 100% Acrylic, Product Number YN2-13, available from Armor Packaging, 3730 Union Pacific Avenue, Los Angeles, Calif. 90023. Both of these materials work best when saturated with water first.

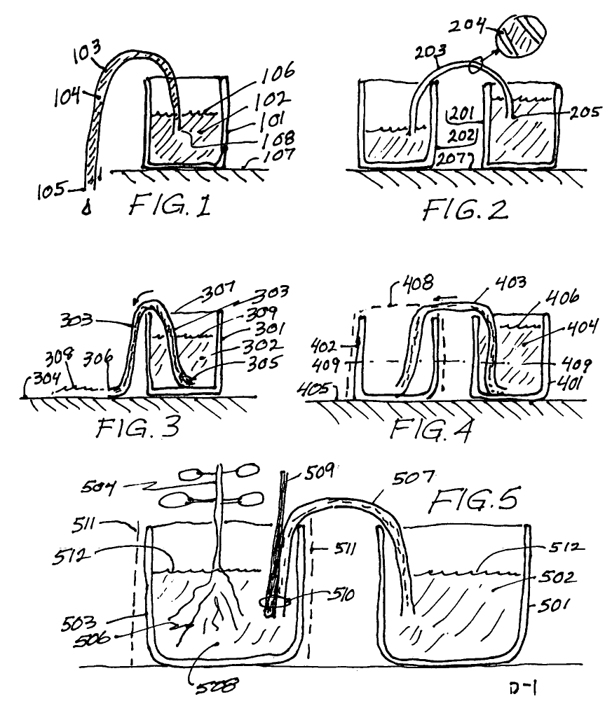

Explaining the invention, FIG. 3 shows an initial condition where a container 301 with contained water 302 a wick 303 and a table top 304 are shown. One end 305 of the wick 303, which may be dry initially, is placed in the water 302 and the other end 306 is placed on the table 304 as shown. The initial water level is shown at 309. This is what happens without the aid of human hands or mouth; water inside the wick ascends the wick to the top of the container 307 and continues inside the wick as it descends in the wick to the end of the wick 306, and then water runs out of the wick forming a puddle 308 on table top, and the puddle gets bigger and bigger, and the water level in the container gets lower and lower until all the water 302 in the container 301 is gone and all the water is now in a puddle 308 on the table top 304.

Explaining the invention, FIG. 4 shows how this discovery can be put to use in order to automatically move water from one container to another. A first container 401, a second container 402, a wick 403, water 404 in container 401 with an initial water level 406, and table top 405 are shown. Water 404 moves up the wick 403 and continues until the water level in container 402 is the same as the water level in 401; the water level is indicated at 409 when equilibrium is reached. Because the water levels in the two containers is the same, knowing what the water level is in container 401 indicates the water level in container 402. This is true even if we make the water level in container 402 completely invisible by surrounding container 402 with an opaque covering 408.

Explaining the invention, FIG. 5 shows how this discovery can be put to use in order to automatically move water from one container to a second container wherein a plant is growing. A first container 501 with water 502 therein, a second container 503 with a plant 504 with roots 506, and a wick 507 are shown. As the plant uses water, water 502 from container 501 moves through the wick 507 into the root growing space 508 in order to replenish water being used by plant 504; the equilibrium water level is indicated at 512. The root growing space 508 may be a soil or may be a hydroponic solution. A stick 509 may be attached to the end of the wick 507, that is in container 503, by an attachment means 510 that might be string or a rubber band. In order to decrease the light to the root growing space 508, a light retarding covering 511, that partially or completely surrounds the root growing space 508, may be used.

Explaining the invention, FIG. 6 shows a first container 601 with water 607, a second container 602 with nutrient solution 603, tray 604 supporting plant 605 with roots 606, and possible positions for wicks where a wick 608 may go down through the tray 604 or where a wick 609 may go down between the tray 604 and the sidewall 610 of the container 602.

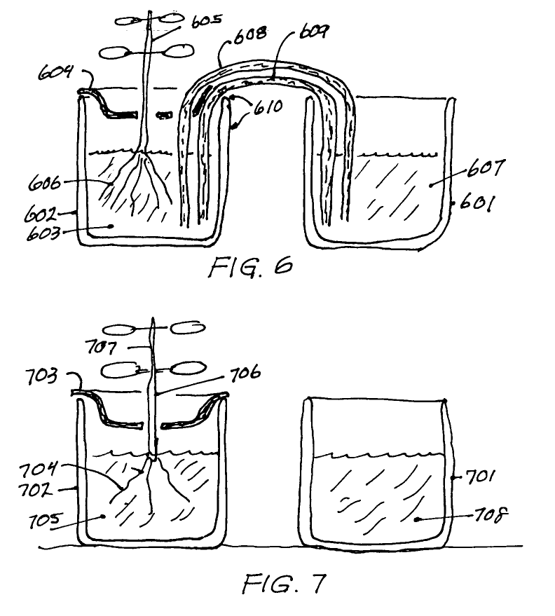

Explaining the invention, FIG. 7 shows a second container 702 with old nutrient solution 705, and a first container 701 with new nutrient solution 708. Also shown with the second container 702 is a tray 703 that supports a plant 707 with stem 706 and roots 704.

### Embodiments of the Invention

All embodiments of the invention seek to add clarity to the claims as originally filed and have the same numbers as the claims as originally filed.

All embodiments of the invention comprise two containers that facilitate the watering and nourishing of plants grown in containers.

Embodiment No. 1 comprises two containers wherein water is conducted from the first container to the second container by employing a wick, as depicted in FIG. 4.

It has been discovered that water may be conducted from one container to another by the use of a wick. To demonstrate this, two containers may be obtained and placed near to each other. Water is placed in the first container and the water level is higher than the water level of the second container, or there may be no water in the second container. The term “does not contain water”, as used in this Specification and claims, means that the container referred to either contains no water at all or that the water level is lower than the water level of the other container. A wick is obtained and one end is placed into the first container and the other end is placed into the second container. Water will flow from the container with the highest water level into the other container. This will continue until the water levels are equal. In this particular embodiment, the wick may be covered with an impervious covering that prevents atmospheric air from entering the water in the wick, thus preventing the aeration of the water therein that is traveling to the second container.

This is a process for conducting water from one container into another container comprising the steps of

a obtaining a first container, wherein said first container contains water, and

b obtaining a second container, wherein said second container does not contain water, and

c obtaining a wick, the shape of which is characterized as being elongate and having a length and two ends, and

d placing one end of the wick in the first container and the other end of the wick in the second container, with the result that water is conducted from the first container into the second container.

Embodiment No 2. This embodiment of the invention comprises Embodiment No. 1 except this embodiment comprises the limitation that roots of a growing plant are growing within the second container as depicted in FIG. 5.

This embodiment of the invention is the process of Embodiment No. 1 wherein roots of a growing plant are located within the second container.

Embodiment No. 3. This embodiment of the invention comprises Embodiment No. 2 except this embodiment comprises the limitation that the roots are growing in soil. The term “soil”, as used in the claims, means any of the solid, fibrous, or granular materials that are normally sold in nurseries for placing in flower pots and in which plants grow, as depicted in FIG. 5.

Embodiment No. 4. This embodiment of the invention comprises Embodiment No. 2 except this embodiment comprises the limitation that the roots are growing in a hydroponic solution located within the second container and the second container is continuous (no hole in bottom, as in an ordinary flower pot), as depicted in FIG. 5. The term “Hydroponic solution” as used in the claims means “water in which nutrients have been dissolved and in which roots grow.”

Embodiment No. 5. This embodiment of the invention comprises Embodiment No. 1 except this embodiment comprises the limitation that a portion of the wick in the second container is connected to a stick, as depicted in FIG. 5. The term “Stick”, as used in the claims, means “any stiff piece of material that is attached to an end of the wick that is used as an aid in pushing the wick down into the root growing space . . . ” This inventor has used sucker sticks as available in craft stores; rods or strips of wood or plastic may also be used. The wick may be attached to the stick by a variety of methods, such methods comprising glue, string, or elastic bands.

Embodiment No. 6 comprises two containers wherein water is conducted from the first container to the second container by a wick that is exposed to air, as depicted in FIG. 6. It is similar to Embodiment No. 1 except that in Embodiment No. 6 there is the limitation that the wick is exposed to air. This is beneficial because air permeates the water in the wick and then this aerated water is conducted by the wick to the root growing space in the second container.

This is a process for conducting water from one container into another container and simultaneously aerating the water comprising the steps of

a obtaining a first container, wherein said first container contains water, and

b obtaining a second container, wherein said second container does not contain water, and

c obtaining a wick, the shape of which is characterized as being elongate and having a length and 2 ends, and

d placing one end of the wick in the first container and the other end of the wick in the second container, with the result that water is conducted from the first container into the second container, and the surface of the wick is exposed to air, thus allowing atmospheric air to enter the water in the wick as it is conducted from the first container into the water of the second container.

Embodiment No. 7. This embodiment of the invention is similar to Embodiment No. 6 except that in this embodiment there is the limitation that roots of a growing plant are located within the second container as depicted in FIG. 6. This is the process of Embodiment No. 6 wherein roots of a growing plant are located within the second container. Roots need oxygen to grow, and when water is oxygenated, the roots grow better. Within this Specification, when the term, “second container does not contain water”, is used, the term means that water may and may not exist in the second container and that if water is present in the second container the water level of the water (or nutrient solution) in the second container is lower than the water level of the water in the first container.

Embodiment No. 8. This embodiment of the invention is similar to Embodiment No. 7 except that in this embodiment there is the limitation that the roots of a growing plant, that are located within the second container, are growing in soil, as depicted in FIG. 5.

This is the process of Embodiment No. 7 wherein roots of a growing plant are growing in soil located within the second container.

Embodiment No. 9. This embodiment of the invention is similar to Embodiment No. 7 except that in this embodiment there is the limitation that the roots, of a growing plant that are located within the second container, are growing in a hydroponic solution, as depicted in FIG. 5.

This is the process of Embodiment No. 7 wherein roots of a growing plant are growing in a hydroponic solution located within the second container, and the second container is continuous (there is no hole in the bottom, as is the case with an ordinary flower pot).

Embodiment No. 10. This embodiment of the invention is similar to Embodiment No. 7 except that in this embodiment there is the limitation that a portion of the end of the wick in the second container is connected to a stick as depicted in FIG. 5 at 509.

This is the process of Embodiment No. 7 wherein a portion of the end of the wick in the second container is connected to a stick.

Embodiment No. 11 comprises two containers wherein the solution level of the second container is not visible, and the water level of the first container is visible and the water level of the first container indicates the solution level in the second container by employing a wick, as depicted in FIG. 4 wherein a light blocking covering is shown at 408. This embodiment of the invention applies directly to addressing the need for an easy to way to determine whether plants grown in containers need more water or not. Especially in a hydroponic application, where the roots of a growing plant hang down into a solution of water in which nutrients have been dissolved, it is not convenient to see what the solution level is in order to determine if more water should be added; this is because the solution is, of necessity, kept in darkness for the purpose of keeping algae from growing. Algae will grow if the solution is exposed to light. Because this inventor discovered that a wick could be used as a means of conveying water from an external source into the root growing space of a hydroponic planter, and discovered that the level of fresh water in the external source is at the same level as the solution, that is kept in darkness and is not visible, a convenient application was discovered. What happens here is that first there is recited a process of conveniently indicating the level of an invisible solution in a second container, and if the level of the invisible solution is lower than desired, water is added to the first container which then moves through the wick into the second container until the levels are equal. After that, details are presented as to how this applies to growing plants.

This embodiment of the invention is a process for determining and correcting the water level within a second container that is not visible

by the process of observing

the water level in a first container that is visible

comprising the steps of

a obtaining said second container containing water with a water level that is not visible because it may be surrounded by opaque material, and

b obtaining said first container, which contains water with a water level that is visible, and

c obtaining a wick, the shape of which is characterized as being elongate and having a length and two ends, and

d placing one end of said wick into the water of said second container, and

e placing the other end of said wick into first container, and

f after allowing sufficient time to pass for water to pass from the second container through the wick into the first container, or from the first container through the wick into the second container, until the water level in the first container is seen to be adequately stabilized, the water levels in the two containers are then equal and the visible water level in the first container directly indicates the invisible water level in the second container, and

g the observer looks at and sees this water level in the first container, and

h adds water to the first container, if the water level in the first container is lower than is desired, indicating that the water level in the invisible second container is also lower than is desired.

Embodiment No. 12. This embodiment of the invention comprises Embodiment No. 11 except this embodiment comprises the limitation that roots of a growing plant are growing in the second container, as depicted in FIG. 5 where covering 511 is used.

Embodiment No. 13. This embodiment of the invention comprises Embodiment No. 12 except this embodiment comprises the limitation that the roots are growing in soil.

Embodiment No. 14. This embodiment of the invention comprises Embodiment No. 12 except this embodiment comprises the limitation that the roots are growing in a hydroponic solution located within the second container and the second container is continuous.

Embodiment No. 15. This embodiment of the invention comprises Embodiment No. 14 except this embodiment comprises the limitation that a portion of the wick in the second container is connected to a stick, as depicted in FIG. 5 at 509.

Embodiment No. 16 comprises two containers facilitating nutrient solution replacement where a wick is employed.

This embodiment of the invention applies directly to the need of an easier way to maintain the nutrient levels required by a plant grown hydroponically. A type of prior art commonly provides for maintaining the desired nutrient levels (chemicals in the water) by periodically analyzing the solution and, when deficiencies are found, to add chemicals as needed to restore the nutrient levels desired. The particular prior art that applies to this invention is the prior art where the solution is not periodically analyzed, but instead the solution is periodically discarded, and fresh nutrient used; this obviates the need for a chemical analysis of the solution. New art, the subject of this embodiment of the invention, is where a hydroponic apparatus comprises a wick that has one end in the nutrient solution of the second container and the other end in a first container that contains water. As the plant uses water, water flows from the first container to second container through the wick. Water is added to the first container as the plant uses water.

A New Art process, (see FIG. 6) for changing the nutrient solution (in a hydroponic apparatus in which there is a first and second container, and in the second container is a nutrient solution, and the second container supports a tray with plants and roots, and the roots hang down into the nutrient solution, and the first container contains water, and a wick is present and is characterized as having two ends, and one end of the wick is in the nutrient solution of the second container, and one end of the wick is in the water of the first container, and as the plant uses water, water flows from the first container into the nutrient solution of the second container), comprising the steps of

a removing the wick from the second container, and

b placing a new nutrient solution into the first container, and

c moving the tray from the second container to the first container, and

d discarding the nutrient solution in second container, and

e placing water in the second container, and

f placing one end of the wick in the water of the second container, and

g placing one end of the wick in the nutrient solution of the first container.

Embodiment No. 17 comprises two containers facilitating nutrient solution replacement wherein the first container is used as a plant support during the period of time when the nutrient solution is being replaced in the second container.

This embodiment of the invention is similar to Embodiment No. 16 except that in Embodiment 17 no wick is required. This embodiment applies directly to the need of an easier way to maintain the nutrient levels required by a plant grown hydroponically. A type of prior art commonly provides for maintaining the desired nutrient levels (chemicals in the water) by periodically analyzing the solution, and when deficiencies are found, to add chemicals as needed to restore the nutrient levels desired. The particular prior art that applies to this invention is where the solution is not periodically analyzed, but instead the solution is periodically discarded, and fresh nutrient used.

Prior Art is cumbersome and can damage the plants when changing the old solution for new. The applicable Prior Art hydroponic apparatus comprises one container, the nutrient solution within, and a tray (supporting plants with roots hanging down into the nutrient solution) with plants. The Prior Art process of changing the nutrient solution comprises the steps of

a removing the tray with plants from the container, and

b placing the tray with plants on its side on a surface (placing the tray with plants on its side can damage the leaves and it is messy as it gets water all over the place), and

c discarding the old solution from the container, and

d placing a new solution in the container, and

e placing the tray with plants into the container with new solution.

New art is convenient and does not damage the plants when changing the old solution for new. The New Art hydroponic apparatus comprises two containers, as depicted in FIG. 7, with the old nutrient solution within the second of the two containers and a tray (that supports the stem and below which the roots hang into the solution) and the first of the two containers that is used during the solution changing process.

The New Art process of changing the nutrient solution comprises the steps of

a placing a new nutrient solution into the first container, and

b removing the tray with plants from the second container, and

c placing the tray with plants into the first container with new nutrient solution, and

d discarding the old nutrient solution from the second container.

It is believed that the two containers that facilitate the watering and nourishing of plants grown in containers of the present invention and many of its attendant advantages will be understood by the forgoing description, and it will be apparent that many various changes may be made in the form, construction and arrangement of the components and of the sequence of the steps thereof without departing from the scope and spirit of the invention without sacrificing all of its material advantages, the form herein described being merely an explanatory embodiment thereof. It is the intention fo the following claims to encompass and include such changes.

What is claimed is:

1. A process for conducting water from one container into another container comprising the steps of
a obtaining a first container, wherein said first container contains water, and
b obtaining a second container, wherein said second container does not contain water, and
c obtaining a wick, the shape of which is characterized as being elongate and having a length and 2 ends, and
d placing one end of the wick in the first container and the other end of the wick in the second container, with the result that water is conducted from the first container into the second container.

2. The process as claimed in claim 1, wherein roots of a growing plant are locate located within the second container.

3. The process as claimed in claim 2, wherein the said roots of a growing plant are growing in soil located within the second container.

4. The process as claimed in claim 2, wherein the said roots of a growing plant are growing in a hydroponic solution located within the second container and the second container is continuous.

5. The process as claimed in claim 1, wherein a portion of the end of the wick in the second container is connected to a stick.

6. A process for conducting water from one container into another container and simultaneously aerating the water comprising the steps of
a obtaining a first container, wherein said first container contains water, and
b obtaining a second container, wherein said second container does not contain water, and
c obtaining a wick, the shape of which is characterized as being elongate and having a length and 2 ends, and
d placing one end of the wick in the first container and the other end of the wick in the second container, with the result that water is conducted from the first container into the second container, and the surface of the wick is exposed to air, thus allowing atmospheric air to enter the water in the wick as it is conducted from the first container into the water of the second container.

7. The process as claimed in claim 6, wherein roots of a growing plant are located within the second container.

8. The process as claimed in claim 7, wherein the said roots of a growing plant are growing in soil located within the second container.

9. The process as claimed in claim 7, wherein the said roots of a growing plant are growing in a hydroponic solution located within the second container and the second container is continuous.

10. The process as claimed in claim 7, wherein a portion of the end of the wick in the second container is connected to a stick.

11. A process for determining and correcting the water level within a second container that is not visible
by the process of observing
the water level in a first container that is visible
comprising the steps of
a obtaining said second container containing water with a water level that is not visible, and
b obtaining said first container, which contains water with a water level that is visible, and
c obtaining a wick, the shape of which is characterized as being elongate and having a length and 2 ends, and
d placing one end of said wick into the water of said second container, and
e placing the other end of said wick into first container, and
f after allowing sufficient time to pass for water to pass from the second container through the wick into the first container, or from the first container through the wick into the second container, until the water level in the first container is seen to be adequately stabilized, the water levels in the 2 containers are then equal and the visible water level in the first container directly indicates the invisible water level in the second container, and
g the observer looks at and sees this water level in the first container, and
h adds water to the first container, if the water level in the first container is lower than is desired, indicating that the water level in the invisible second container is also lower than is desired.

12. The process as claimed in claim 11 wherein the roots of a growing plant are located within the second container.

13. The process as claimed in claim 12, wherein the said roots of a growing plant are growing in soil located within the second container.

14. The process as claimed in claim 12, wherein the said roots of a growing plant are growing in a hydroponic solution located within the second container and the second container is continuous.

15. The process as claimed in claim 12, wherein a portion of the end of the wick in the second container is connected to a stick.

16. A process for changing the nutrient solution (in a hydroponic apparatus in which there is a first and second container, and in the first container is a nutrient solution, and the first container supports a tray with plants and roots, and the roots hang down into the nutrient solution, and the second container contains water, and a wick is present and is characterized as having two ends, and one end of the wick is in the nutrient solution of the first container, and one end of the wick is in the water of the second container, and as the plant uses water, water flows from the second container into the nutrient solution of the first container), comprising the steps of
a removing the wick from the first container, and
b placing a new solution into the second container, and
c moving the tray from the first container to the second container, and
d discarding the nutrient solution in the first container, and
e placing water in the first container, and
f placing one end of the wick in the water of the first container, and
g placing one end of the wick in the nutrient solution of the second container.

17. A process for changing the nutrient solution in a hydroponic apparatus (comprising two containers, the second container contains old nutrient solution and supports a tray supporting plants and roots that hang down into the old nutrient solution, and the first of the two containers is used during the solution changing process) comprising the steps of
a placing a new nutrient solution into the first container, and
b moving the tray with plants from the second to the first container, and
c discarding the old nutrient solution from the second container.
